(19) United States
(12) Patent Application Publication
(10) Pub. No.: US 2016/0019357 A1
(43) Pub. Date: Jan. 21, 2016

(54) HEALTHCARE ANALYTICS SYSTEM AND METHOD

(71) Applicant: THE BANK OF NEW YORK MELLON, New York, NY (US)

(72) Inventors: Vincent MARZULA, Pittsburgh, PA (US); Rose WOJCIECHOWSKI, Pittsburgh, PA (US); Valerie RODGERS, Pittsburgh, PA (US); Paolo CORTICELLI, New York, NY (US)

(21) Appl. No.: 14/744,674

(22) Filed: Jun. 19, 2015

Related U.S. Application Data
(60) Provisional application No. 62/015,166, filed on Jun. 20, 2014.

(51) Int. Cl. G06F 19/00

(52) U.S. Cl. CPC G06F 19/328

(57) ABSTRACT

A system for providing data analytics at a healthcare entity comprises a computer system comprising one or more physical processors programmed with computer program instructions. When the computer program instructions are executed, the computer system receives data associated with a healthcare provider's operation and performance from one or more data sources. The data received from the one or more data sources is then aggregated and converted into a single format. The aggregated data is processed utilizing one or more data analytics models to generate healthcare analytics data which is then used to provide analytics and reporting based on the healthcare provider's operation and performance. Visualizations of the provided analytics and reporting are generated for display on a user interface.

### RELATED APPLICATION

This application claims priority to U.S. Provisional Patent Application No. 62/015,166, filed on Jun. 20, 2014, which is incorporated by reference herein in its entirety.

### BACKGROUND

This application is directed to computer-implemented systems and methods for providing healthcare analytics. It finds particular application in providing an integrated and customizable view of key business drivers within a healthcare system to aid in strategic decision-making in a current, near- and long-term healthcare environment and will be described with particular reference thereto.

The Affordable Care Act (ACA) is radically changing existing healthcare provider business models. For example, existing reimbursement models for healthcare providers are changing from pay for service to pay for performance. The ACA's establishment of Accountable Care Organizations (ACO) has also altered existing healthcare provider business models. With the addition of ACOS, the existing model of payment for individual services has changed to entire care management from one capitation payment to bundled payment. Further, high deductible plans place higher direct out of pocket expenses on patients thus providing an unreliable revenue stream (accountable up to $5,200 before insurance starts up to $12,500 per year). The lowering of government reimbursement (Medicare and Medicaid) levels under the ACA and the increase of commercial payers lowering reimbursement models has also affected healthcare provider business models. Additionally, many legislative changes, such as electronic medical records and the International Statistical Classification of Diseases and Related Health Problems (ICD-10), are limiting in-house healthcare provider resources.

The current regulatory environment related to the Affordable Care Act and the seismic changes regarding financial reimbursement are the catalyst for change in the healthcare market. Efficient organizations are looking for tools to make better business decisions, reduce costs, and improve operating efficiency. Some of the challenges faced by healthcare providers include reduced insurance reimbursements, changing payment models, increasing patient out-of-pocket responsibility, rising operating costs, difficult economic conditions, expensive legislative mandates, ineffective planning of cash flow needs, financial errors in cash management and budgeting, relying on basic spreadsheets for reporting and analysis to make financial and budget decisions, spending significant time tracking down information and reporting, continued evolvement of hospitals from standalone facilities to widespread multi-site networks.

A need exists for a data analytic system and method that provides performance monitoring and decision support in the healthcare environment which overcomes the above-references problems and others.

### SUMMARY

A system for providing data analytics at a healthcare entity comprises a computer system comprising one or more physical processors programmed with computer program instructions. When the computer program instructions are executed, the computer system receives data associated with a healthcare provider's operation and performance from one or more data sources. The data received from the one or more data sources is then aggregated and converted into a single format. The aggregated data is processed utilizing one or more data analytics models to generate healthcare analytics data which is then used to provide analytics and reporting based on the healthcare provider's operation and performance. Visualizations of the provided analytics and reporting are generated for display on a user interface.

A method for providing data analytics at a healthcare entity is provided. The method is implemented on a computer system comprising one or more physical processors programmed with computer program instructions that, when executed, cause the computer system to receive data associated with a healthcare provider's operation and performance from one or more data sources. The data received from the one or more data sources is then aggregated and converted into a single format. The aggregated data is processed utilizing one or more data analytics models to generate healthcare analytics data which is then used to provide analytics and reporting based on the healthcare provider's operation and performance. Visualizations of the provided analytics and reporting are generated for display on a user interface.

### BRIEF DISCUSSION OF THE DRAWINGS

FIG. 1 illustrates an embodiment of a high-level system for providing healthcare analytics;

FIG. 2 illustrates another embodiment of a system for providing healthcare analytics;

FIG. 3 illustrates an exemplary computer system configured to perform the functions of systems and methods described herein;

FIG. 4 illustrates an embodiment of a logical architecture of a system for providing healthcare analytics;

FIGS. 5-7 illustrate exemplary embodiments of account/investment analytic interfaces;

FIGS. 8-12 illustrate exemplary embodiments of cash flow analytics interfaces;

FIGS. 13-16 illustrate exemplary embodiments of revenue cycle analytic interfaces;

FIGS. 17-20 illustrate exemplary embodiments of clinical analytic interfaces;

FIG. 21 illustrates an exemplary embodiment of a supply chain analytic interface;

FIG. 22 illustrates an exemplary embodiment of an account payable/receivable analytic interface;

FIG. 23 illustrates an exemplary embodiment of a key performance indicator interface;

FIG. 24 illustrates a flowchart depicting an embodiment of a method of the present disclosure.

### DETAILED DESCRIPTION

In the discussion of various embodiments and aspects of the system and method of this disclosure, examples of a processor may include any one or more of, for instance, a personal computer, portable computer, personal digital assistant (PDA), workstation, or other processor-driven device, and examples of network may include, for example, a private network, the Internet, or other known network types, including both wired and wireless networks.

Those with skill in the art will appreciate that the inventive concept described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

Described herein is an exemplary system which may be implemented through computer software running in a processor to provide healthcare analytics. This description is not intended to be limiting, but is merely provided to describe ways of accomplishing the functions associated with analyzing data across a healthcare environment and providing valuable insights into current trends within a healthcare provider, predict future performance, and prescribe actions to drive desirable results. In one embodiment, the healthcare analytics provide a user interface that enables a user to view and manipulate integrated data relating to revenue cycles, investments, supply chains, and clinical and population health metrics. In another embodiment, the healthcare analytics forecast and predict future trends by using predictive modeling tools. In another embodiment, the healthcare analytics accelerate and simplify decision-making with access to enterprise-wide data, and minimize manual and labor intensive reporting. In another embodiment, the healthcare analytics reduces organizational risk by helping to provide insight at a strategic level.

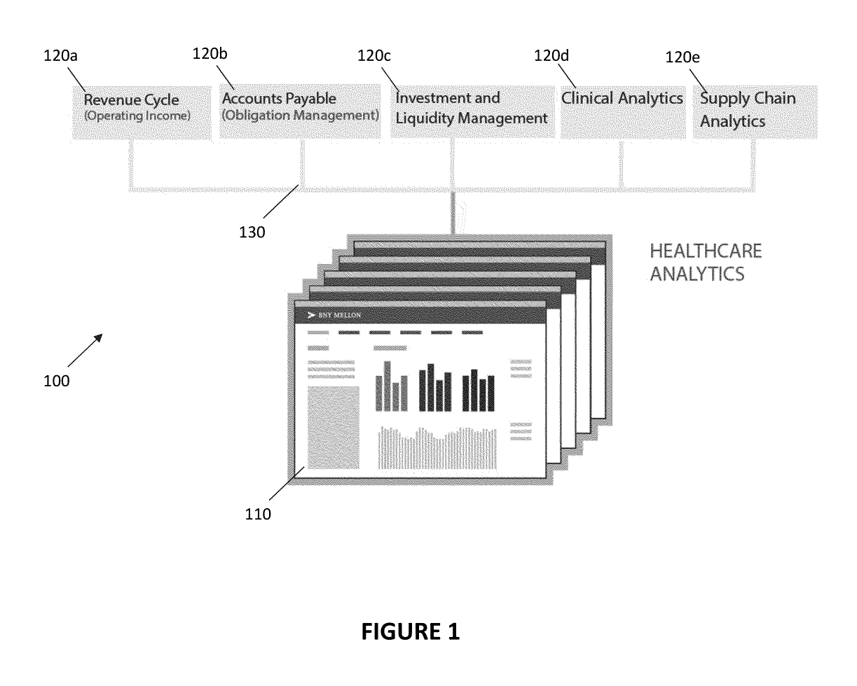

FIG. 1 schematically illustrates a configuration of a high-level system for providing healthcare analytics of a healthcare entity 100. As shown, the healthcare entity 100 includes a healthcare analytics processor 110 interconnected to plurality of data sources 120 (e.g. databases) via a network connection 130. It may be appreciated that the data sources may be internal or external to the healthcare entity 100. In the illustrated embodiment, there are five data sources 120 including a revenue cycle (operating income) data source 120a, an accounts payable (obligation management) data source 120b, an investment and liquidity management data source 120c, a clinical analytics data source 120d, and a supply chain analytics data source 120e. In one embodiment, the data sources 120 may include one or more databases which store data relating the revenue cycle, accounts payable, investments and liquidity, clinical analytics, and/or supply chain analytics associated with a healthcare entity 100. It may be appreciated that the data sources 120 may comprise discrete databases or a single database at the healthcare entity 100. It may also be appreciated that the data sources 120 stores various types of data in multiple formats which can be utilized by the healthcare analytics processor 110 to provide performance monitoring and decision support.

As described in greater detail below, the healthcare analytics system 110 integrates data stored in the data sources 120 and provides a computational analysis of the data. It may be appreciated that the healthcare analytics processor 110 retrieves the data stored in the data sources 120 and provides one or more user interfaces that enable a user to view and manipulate integrated data relating to revenue cycles, investments, supply chains, and clinical and population health metrics on a display. In another embodiment, the healthcare analytics forecast and predict future trends by using predictive modeling tools from the retrieved data. In another embodiment, the healthcare analytics accelerate and simplify decision-making with access to enterprise-wide data, and minimize manual and labor intensive reporting. In another embodiment, the healthcare analytics reduces organizational risk by helping to provide insight at a strategic level.

In one embodiment, the healthcare analytics processor 110 generates an integrated data model relating to revenue cycles, investments, supply chains, and clinical and population health metrics associated with the healthcare entity 100. In another embodiment, the healthcare analytic system 110 forecasts and predicts future trends of the healthcare entity 100 utilizing predictive modeling tools. In another embodiment, the healthcare analytics processor 110 provides tools which assist in the decision-making process. In another embodiment, the healthcare analytic system 110 provides an insight of the healthcare entity 100 at a strategic level. It may be appreciated that the healthcare analytics processor 110 may also analyze data from the plurality of data sources 120 and provide valuable analysis into current trends, predict future performance, and prescribe actions to drive desirable results within the healthcare entity 100.

It may also be appreciated that the healthcare analytics processor 110 may be operated by different users at the healthcare entity 100. For example, the healthcare analytics system 110 may be operated by a different employee, each with associated tasks and responsibilities assigned thereto. While the healthcare analytics processor 110 may be coupled to the healthcare entity 100 by internal network connections 130 in some embodiments (e.g., a network within the business entity 100), in other embodiments, the healthcare analytics processor 110 may be coupled to the healthcare entity 1100 by any other appropriate connection, including but not limited to terminal connections, or over an network that extends outside the healthcare entity 100 (e.g., the internet).

In an embodiment, the healthcare analytics processor 110 may comprise a system that itself includes one or more physical computer processors. The network connection 130 and other such components associated with the transfer of data through the healthcare entity 100 may be configured with a sufficiently low latency to facilitate receiving and processing a plurality of events simultaneously (e.g., thousands of events per second, in an embodiment), which may contemporaneously be displayed to a user of the healthcare analytics processor 110 (e.g., via a user interface to the healthcare analytics processor 110). In some embodiments, the healthcare analytics processor 110 may operate on a cloud (e.g., a network of computer systems) associated with the healthcare entity 100.

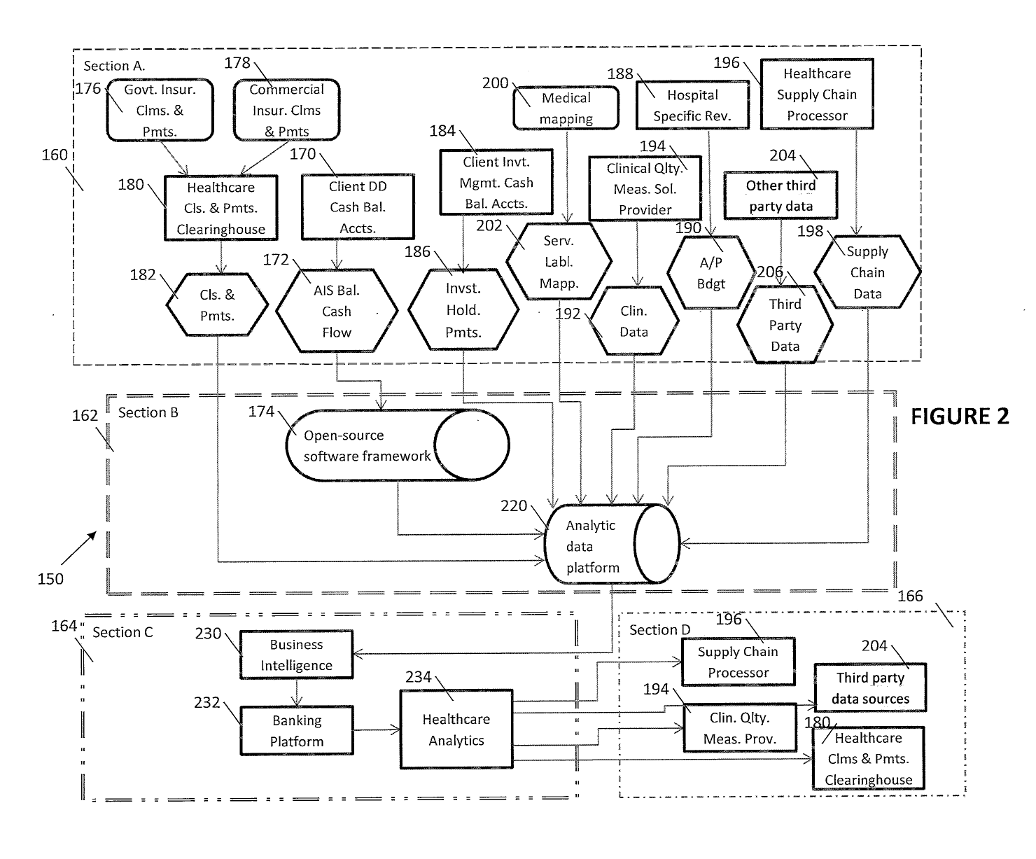

FIG. 2 illustrates another embodiment of a healthcare analytics system 150 for providing healthcare analytics of a healthcare entity 100. It may be appreciated that the healthcare analytics system 150 may be configured to provide users of the healthcare entity 100 (e.g., management and operations users) with analytical reportings and/or performance measurements (Key Performance Indicators (KPI)/Benchmarking) associated with the healthcare entity 100. In an embodiment, the healthcare analytics system 150 may provide users of the healthcare entity 100 a balance scorecard to keep track of the execution of activities by the staff within the user's control and to monitor the consequences arising from these actions. In another embodiment, the healthcare analytics system 150 may also provide KPIs by department to measure progress and success of a particularly activity in which the department is engaged. In another embodiment, the healthcare analytics system 150 may further provide the ability for the user to manage the interdependencies between departments and assist in decision making within the healthcare entity 100. It may be appreciated that the healthcare analytics system 150 may provide the analytics reporting and/or performance measurements in contemporaneous (e.g., real time) manner, predictive (trending the future) manner, or prescriptive (directing the future) manner.

As described in greater detail below, the healthcare analytics system 150 may be configured to provide analytical reportings and/or performance measurements associated with the healthcare entity 100 via one or more interfaces. In an embodiment, the healthcare analytics system 150 may aggregate and analyze the data from data sources 120 to provide the healthcare analytics. As further described herein, the system 150 provides integrated data interfaces which enable the user to view and manipulate integrated data on revenue cycle, investments, supply chain, clinical and population health metrics; forecast and predict future trends utilizing modeling tools; accelerate and simplify decision-making with access to enterprise-wide data and reporting; reduce organizational risk by providing KPIs which can be used to monitor business performance; create a customizable view of key business drivers within a health system enabling the user to make strategic decisions in the current, near, and long-term healthcare environment; and/or develop what-if scenario analysis as part of the prescriptive and decisioning solution as well as a highly flexible and customizable enterprise-wide balanced scorecard model to align all constituent entities behind an organization's performance goals with constant performance monitoring capabilities.

As shown in an embodiment of the healthcare analytics system 150 in FIG. 2, the system 150 may comprise four disparate layers of functionality. In particular, the healthcare analytics system 150 may comprise a data collection layer 160, a data aggregation layer 162, a data analytics layer 164, and business support layer 166.

As shown, in an embodiment, data is stored in one or more data sources 120 in the data collection layer 160. It may be appreciated that the data collection layer 160 illustrates the data flow that starts with data collection and extraction at specific data sources 120. It may also be appreciated that the data stored may be in various formats and types which can be utilized by the healthcare analytics processor 110 to provide performance monitoring and decision support. It may be appreciated that the data stored in the data sources 120 is natively in a diverse variety of formats that must be converted to a standard format that enables the healthcare analytics system to provide data analytics. In one embodiment, the data sources 120 include client demand deposit cash balance accounts 170 that store data relating to income or revenue accounts from clients. This data, in the form of cash, is collected, processed and stored by a financial institution in accounts owned by the healthcare entity 100. It may be appreciated that the financial institution of the healthcare entity 100 transmits AIS balances and summary cash flow data 172 to the data aggregation layer 162 where it is processed via open-source software framework for storage and large scale processing 174. AIS balances are the amount of available funds the healthcare entity 100 has in their demand deposit account at the end of each business day that are automatically transferred into an investment instrument. This service maximizes the investment value of otherwise idle funds within a brief timeframe. Not all funds may be designated for the automatic investment service; therefore, the total amount of all available cash will be reported each day. It may be appreciated that the client demand deposit cash balance account 170 receives payments (credits) for outstanding accounts receivable (A/R) balances and disbursements (debits) for accounts payable (A/P) processing.

In another embodiment, the data sources also store data from cash balance accounts which include claim payments received from government insurance claims and payments 176 and commercial insurance claims and payments 178 such as funds collected via a lockbox (paper) and electronic payments such as those from an. Automated Clearing House (ACH) 180. The government insurance claims and payments 176 and commercial insurance claims and payments 178 are a source of Electronic Data Interchange or EDI 837 healthcare insurance claims data 182 or Electronic Data Interchange or EDI 835 claim payment transactions data 182. It may be appreciated that the ACH 180 provides medical billing services as an alternative to in-house staff for a variety of day-to-day back office tasks. The ACH 180 also provides for automated demographic data input to patient eligibility verification, outsourced coding, service charge entry, paper remittance processing, payment posting, and the like. The ACH 180 also provides coding services and value-added services like reconciliation, compliance reporting and educational feedback to providers. The ACH 180 also streamlines the transactions between healthcare Insurance Payers and Providers by instituting edits and rules needed for straight-through processing. It may also be appreciated that the claims and payment data 182 include healthcare claims and payments clearinghouse files including patient demographic information such as zip code and the like; financial claim data including claim amounts, expected payments, billing provider, insurance parties, claim start/end dates, claim submission dates, facility, rendering physician, and the like; and financial payment data including claim payment by insurance, billing provider, insurance party payments, patient responsibility amounts, insurance party adjustments (claim level—amounts and adjustment codes), insurance party adjustments (provider level—amounts and adjustment codes), and the like.

In another embodiment, the data sources include client investment management cash balance accounts 184 which include investment holdings, security payments and redemptions. The client investment management cash balance accounts 184 provides previous day cash balance, current day cash balance, and a 5 day projected cash balance in the form of investment holdings, security payments, and redemption data 186. It may be appreciated that the client investment management cash balance accounts 184 include investment holdings, security payments, cash transfers and redemptions, and the like. It may also be appreciated that the client investment management cash balance accounts 184 further include asset holdings (security, shares, Net Asset Value, etc.), portfolio security level data and reporting, performance measurements, performance attributions, risk analysis, forward looking risk analytics, peer group analysis, Foreign Exchange reporting, security lending reporting, and the like.

In another embodiment, cash or revenue including hospital provided revenue data 188 can also be stored in the data sources 120. This hospital provided revenue data 188 includes A/P data and/or budget and planning data 190 relating to income or revenue generated directly by the hospital or by sources associated with the healthcare entity 100 that are collected, tracked and stored by the healthcare entity 100. This is commonly known or referred to as accounts receivable data. It may be appreciated that the A/P data and/or budget and planning data 190 include accounts Payable data containing all the money owed by the healthcare entity 100 to its suppliers, employee payroll, and other liabilities and/or debts. The budget and plan data 190 may also be provided in addition to actual figures for comparison and performance analysis to determine how favorable or unfavorable the organization is from their planned expense budget.

In another embodiment, the data sources 120 stores clinical data 192 including all information collected during the patient encounter at the healthcare provider. The clinical data 192 is collected processed and stored by the Clinical Quality Measurements solutions provider 194 and consists of clinical and quality outcomes based upon a healthcare organization's performance results from their treatment and care of patients. The Clinical Quality Measurements solution provider 194 provides clinical information for the healthcare entity 100 at an enterprise, facility, specialty, and/or physician level. This data consists of clinical and quality outcomes based upon a healthcare entity's performance results from their treatment and care of patients. This data provides a holistic view of performance related to finance, patient satisfaction, and clinical indicators. In addition, benchmark data will be provided for performance measurement.

In yet another embodiment, the data sources 120 include health supply chain management solutions 196 which captures, processes and stores supply chain data 198 which includes all information collected on the purchasing of durable equipment, medical supplies, etc. used by the healthcare entity 100. It may be appreciated that the healthcare supply chain management solution 196 works with the healthcare entity 100 to implement order processing efficiency that helps reduce supply chain costs. It may also be appreciated that the supply chain data 198 includes an individual client's data performance or aggregated customer data for benchmarking purposes such as inventory metrics (i.e. average shelf day, turn-over, etc.), on-contract spend, off-contract spend, supplier metric (backorders, rejects, purchase orders, etc.), facility and provider insight, and the like. For example, the healthcare supply chain management solution 196 generates supply chain data 198 that includes the healthcare entity's inventory days on shelf and compares their metric to a benchmark of aggregated customer data.

In another embodiment, the data sources 120 stores medical data mapping tables, guidelines and standards 200 including service label data, department mapping data, etc. 202 obtained from professional healthcare associations and organization. It may be appreciated that the professional healthcare associations and organization provide provides EDI publications and tools and include Blue Cross and Blue Shield association, CAQH (a nonprofit alliance of health plans and trade associations), CMS (Centers for Medicare and Medicaid Services), and the like. It may also be appreciated that the service label data, department mapping data, etc. 202 include claim level adjustments codes: (Washington Publishing Company and CAQH CORE), provider level adjustments codes: (Washington Publishing Company), internally built data tables driven off of Bill Types and Frequency Types to create Inpatient/Outpatient classifications: (Blue Cross Blue Shield of Illinois (Division of Healthcare Service Corporation), service code definitions (HCPCS Codes) CMS (Centers for Medicare and Medicaid Services), internally built data table driven off of Claim Filing Indicator to create insurance provider classification (e.g. gov't, commercial, etc.) (Washington Publishing Company 5010 835 File Specification Document), and the like.

It may also be appreciated that any claim and payment data can be collected, processed and stored by the ACH 180 or other similar third party processing sources 204 of this data. The ACH 180 and third party processing sources 204 also provide KPI data 206 that is transmitted to be processed and stored in the data aggregation layer 162. The KPI data containing aggregated electronic remittance advices and average payment time. It may be appreciated that the KPI data also include operating cash, day cash on hand, aged AIR % of Final billed A/R, initial Zero-Pay Denial Rate, inpatient claims, outpatient claims, institutional revenue, professional revenue, coordination of benefits, average Length of Stay, and the like. It may also be appreciated that the third party processing sources 204 provide data to the ACH 180 on a healthcare entity's behalf and from bank lockboxes to convert paper to electronic transactions. These third party data sources processing sources 204 deliver a broader range of services surrounding all of the healthcare (HIPAA) transactions: 835s, 837s, 270, 271, 275, 276, 277, etc.

As shown, in an embodiment, data that is extracted from the data collection layer 160 is transmitted and received in the data aggregation layer 170. Once the data from the collection layer 160 is received, standard Java processes load the data into the open-source software framework 174 for storage and large-scale processing for further processing. As described above, the data stored in the data source 120 incudes various formats and types. The further processing performed by the source software framework 174 aggregates the data into a standard data format appropriate for input into the data analytics layer 164. In one embodiment, open-source software framework 174 reformats the data (in various data types and formats) to a standard format which is processed by the analytics data analytic layer 164. After this final processing, the aggregated data resides in the analytic data platform 220 which consolidates data from different sources for storage and access by analytic visualization tool 230 in the data analytics layer 164.

As further shown in FIG. 2, in another embodiment, the data analytics layer 164 includes the analytics visualization tool 230, an electronic banking platform 232, and a healthcare analytics processor 234. The analytics visualization tool 230 analyzes the data received from the analytic data platform 220 and generates one or more interface that constitutes the presentation layer of the healthcare analytics system and provides the analytical data interface on a display for the user. User access to the data analytics layer 164 is provided through an entitlements process in the electronic banking platform 232. The electronic bank platform 232 also delivers information reporting and transaction initiation functionality. The healthcare analytics processor 234 provides clients with the option to assign access to specific functionality based on the business need of a user at the healthcare entity 100.

Some of the analytics which may be performed on the received data may include providing one or more interfaces that enables a user to view and manipulate integrated data relating to revenue cycles, investments, supply chains, and clinical and population health metrics.

In one use case, visualization tool 230 and/or healthcare analytics processor 234 may map the data stored in the one or more data sources 120. For example, visualization tool 230 and/or healthcare analytics processor 234 may map data to populate the various interfaces. For example, data relating to cash accounts may be mapped to various interfaces for AIS balances, summary cash flow, investment holdings, security payments, redemptions, and the like. In another example, the same data may be processed by the visualization tool 230 and/or healthcare analytics processor 234 to generate one or more interfaces relating to claims and payment data, service labels, department mappings, KPIs, average payments times, clinical data, budget and planning data, supply chain data, and the like.

In one embodiment, healthcare analytics processor 234 may aggregate and/or filter the data stored in the one or more data sources 120 based on various attributes, For example, healthcare analytics processor 234 may aggregate and filter data for claims, payments, or a combination of both. The attributes may include, but are not limited to, date, facility, specialty, physician, payer, professional/institution type, insurance types, claim aging, and the like.

In another embodiment, healthcare analytics processor 234 may perform assignment functionality on the stored data. For instance, stored data may be assigned to one or more attributes. For example, payments and claims may be assigned to a medical specialty. In this example, payment and claims may be assigned to a physician or medical specialty based on the physician NPI value which corresponds to the physician or medical specialty provided in the data or provided assignment table which associates a physician to a medical specialty. If more than one physician exists, the first claim encountered it match with the claim and/or payment data. Similarly, in another embodiment, data may be assigned to various professional and/or instructional types. For instance, an assignment table may be utilized to associate physicians to a professional and/or instructional type, Each payment may then be linked back to the related claims/payment in order to provide a corresponding professional and/or instructional type. The professional and/or instructional types may then be linked or associated with a particular payment.

In another embodiment, analytics visualization tool 230 and/or healthcare analytics processor 234 may forecast claims and payment activity. For example, historic claims and payment data may be analyzed by analytics healthcare analytics processor 234 over a predetermined timeframe. Based on the historical trending, healthcare analytics processor 234 may determine a predicted volume/dollar amount of future claims utilized various algorithm (i.e. straight line, standard deviation, etc.) In another embodiment, healthcare analytics processor 234 may forecast or predict future trends based on stored industry averages or target data provided by the user. Upon completion of the processing, the outstanding claims may then be analyzed to forecast future claims and payment activity.

For example, with respect to cash accounts and investments, the analytics visualization tool 230 and/or healthcare analytics processor 234 may generate an interface comprised of data from investment management as well as working capital management and is designed to help the client understand their historical, current, and future financial situation. The data displayed on the investment management, or assets, interface is comprised of cash balances. These accounts have the ability to be projected out 5 days and have an embedded link to a client investment management system for more detailed information. The data displayed in the working capital management, or treasury, dashboard includes historical and current information on beginning and ending balances of various accounts. The user has the ability to view data based on account type and using a date filter. In another example, with respect to cash flow, the analytics visualization tool 230 and/or healthcare analytics processor 234 may generate an interface that provides the user an understanding of their operating cash position as well as where their sources of revenue are coming from. The user has the ability to display data at a facility, specialty or physician level and track and monitor performance by using an index of key performance indicators. Some examples of information being displaying are operating cash totals, days cash on hand, and patient revenue. Users also have the ability to input data pertaining to their specific business and set targets.

In particular, analytics visualization tool 230 and/or healthcare analytics processor 234 may generate cash flow analytics for a healthcare entity including, but not limited to, operating cash and days cash on hand values with their percentage difference between each day. In one embodiment, healthcare analytics processor 234 utilizes the stored data to calculate the operating cash (Operating Cash=Payer Payment Amt+Patient Responsibility Amt+Provider Adjustment Amt), days cash on hand (Operating cash/Daily Cash Burn Rate from Industry average table), and/or the percentage change (% Calculation=(Current day−prior day)/prior day). It should be appreciated that the analytics visualization tool 230 may generate a visualization of the analytics. For example, a chart with the horizontal axis including the deposit date from payments and the vertical axis including average of days cash on hand may display a days cash on hand analytic. A chart with a horizontal axis including deposit date from payments and a vertical axis including summation of operation cash may display an operating cash analytic.

In another example, with respect to revenue cycles, the analytics visualization tool 230 and/or healthcare analytics processor 234 may generate an interface that enables the user to gain insight into the organization's process for managing claim processing, receiving payment and generating revenue. It is important to keep track of the claim at every point in its life cycle, therefore, the invention provides this ability through graphs such as total claims in AR, total claims by insurance type, payer comparisons, payer versus patient payment and so on. These dashboards also address denied claims and adjustments taken on those claims which ultimately affect the organization's revenue opportunity. There are various filters, as mentioned above, as well as key performance indicators specific to revenue cycle. With respect to clinical information, the analytics visualization tool 230 and/or healthcare analytics processor 234 may generate an interface that addresses many important factors dealing strictly with the financial performance of the organization in regards to treating patients. This includes volume of inpatient and outpatient visits, length of stay, volume by specialty, geographical patient distribution and much more. In addition, the invention provides benchmarking of clients against industry averages and tracking particular key performance indicators over time. This directly helps organizations become more efficient and so they are able to provide higher quality care.

In particular, analytics visualization tool 230 and/or healthcare analytics processor 234 may generate revenue related analytics for a healthcare entity including revenue cycle, average A/R days outstanding, claims lifecycle, billed vs. paid, payer comparison, total claims by insurance type, account receivable, total claims in A/R, days in A/R by payer, claims adjustments data, and the like. In one embodiment, healthcare analytics processor 234 utilizes the stored data to calculate the revenue cycle (Total Claims in A/R=Summation of Claim Amount (Total Claim Charge Amount) providing the total claim value for the prior day and the percentage difference between prior day's and day before prior day's claim amounts. In another embodiment, healthcare analytics processor 234 utilizes the stored data to calculate the average number of days outstanding for claims on prior day (Days Outstanding=Effective Date−Claim Bill Date) and the percentage difference between prior day's and day before prior day's average days outstanding. In another embodiment, healthcare analytics processor 234 utilizes the stored data to calculate the claim lifecycle including the discharge to claim submission (Lifecycle Days=Claim bill date Claim end date) and claim submission to claim payment (Lifecycle Days=Payment Deposit date−Claim end date). Analytics visualization tool 230 may generate a visualization of the claim lifecycle displaying the month of effective date on the horizontal axis, average of lifecycle days on the vertical axis, and the lifecycle in various color-codes. In another embodiment, analytics visualization tool 230 and/or healthcare analytics processor 234 may utilize the stored data to calculate a billed vs. paid analytic and generate a visualization including the payer on the horizontal axis, summation of claim amount on vertical axis, and claim status in color-codes. In another embodiment, healthcare analytics processor 234 utilizes the stored data to calculate a total claims in A/R (Total Claims in A/R Summation of Claim Amount (Total Claim Charge Amount) and/or claims billed in a particular time period (Claims Billed amount=Summation of current month's claim amounts (Total Claim Charge Amount)) including the percentage change. In another embodiment, analytics visualization tool 230 and/or healthcare analytics processor 234 may utilize the stored data to generate CAS adjustment analytics relating to CAS adjustments, total CAS non-CAS adjustments, top contractual adjustments, top CAS patient responsibility adjustments, top CAS other adjustments, top CAS payer initiated adjustments, total claim adjustments, and the like. In another embodiment, analytics visualization tool 230 and/or healthcare analytics processor 234 may utilize the stored data to generate provide adjustment analytics relating to total PLB debit adjustments, total, PLB credit adjustments, top PLB adjustments, PLB adjustments, and the like. In another embodiment, healthcare analytics processor 234 utilizes the stored data to calculate denial rate analytics including zero-pay denial rates (Denial Rate=SUM (IF [Denial_Rec]=‘Y’ THEN [Number of Records] ELSE 0 END)/TOTAL(SUM([Number of Records])). Analytics visualization tool 230 may generate a visualization of the zero-pay denial rates analytic including the payment deposit date on the horizontal axis, denial rate in percentage value on the vertical axis, and a filter (facility, specialty, payer, and physician) in color-codes.

In another example, with respect to clinical data, the analytics visualization tool 230 and/or healthcare analytics processor 234 may generate an interface that enables the user to gain insight into the clinical aspects of the healthcare entity. For example, analytics visualization tool 230 and/or healthcare analytics processor 234 may utilize the stored data to generate revenue by location analytics which may include a patient's zip code, patient revenue, and volume being shown on a map. In one embodiment, circles may be used to visually indicate the location analytics and the sizes of circles on the map may define the payment amount for each location. In another embodiment, analytics visualization tool 230 and/or healthcare analytics processor 234 may utilize the stored data to generate revenue trend analytics including inflated revenue, total clinical revenue, facility revenue, medical specialty revenue, physician revenue, payer revenue, professional and institutional revenue, and the like. In another embodiment, analytics visualization tool 230 and/or healthcare analytics processor 234 may utilize the stored data to generate the volume analytics such as inpatient/outpatient volume, medical specialty volume, facility volume, and the like.

In another example, with respect to KPIs, the analytics visualization tool 230 and/or healthcare analytics processor 234 may generate an interface that enables the user to gain insight into the key performance indicators of the healthcare entity. For example, analytics visualization tool 230 and/or healthcare analytics processor 234 may utilize the stored data to generate a scoreboard utilizing industry averages, target data supplied by the customers, and the like. In one embodiment, the KPIs may be shown on the individual dashboards (e.g. Cash Flow, RevenueCycle and Clinical). The charts in scorecard may differ from the other dashboards in the sense that scorecard shows a 6 month trend versus just a singular month. In one embodiment, the customer is able to adjust the time period for each KPI. In one embodiment, analytics visualization tool 230 and/or healthcare analytics processor 234 may utilize the stored data to generate a revenue cycle KPIs including aged A/R % of final billed A/R (Aged A/R %=(Claim_Amt Payment_Amt)/Claim_Amt), zero-pay denial rate (Denial Rate=Count of Primary Payer Payments by month where Claim Status Code=4/Count of total Primary Payer Payments by month), inpatient claims (summation of number of claims associated with inpatient services), outpatient claims (summation of number of claims associated with outpatient services), institutional revenue (summation of Claim amounts associated with the hospital billing areas), professional revenue (summation of Claim amounts associated with the physician group areas), coordination of benefits (summation of Claim amounts associated with more than a Primary Payer. Count Claim Amount only once for a given Patient Claim), and the like. In one embodiment, analytics visualization tool 230 and/or healthcare analytics processor 234 may utilize the stored data to generate a clinical KPIs including average length of stay (Monthly average for summation of Length of Stay; Length of Stay=(Claim End Date−Claim Start Date)), average revenue per facility (Monthly average for summation of Revenue per Facility; Revenue per Facility=Total Revenue/Number of Facilities), average revenue per specialty (Monthly average for summation of Revenue per Specialties; Revenue per Specialty=Total Revenue/Number of Specialty), average revenue per physician (Monthly average for summation of Revenue per Physician; Revenue per Physician=Total Revenue/Number of Physicians), average revenue per encounter (Monthly average for summation of Revenue per Encounter; Revenue per Encounter=Total Revenue/Number of Encounters), and the like. In one embodiment, analytics visualization tool 230 and/or healthcare analytics processor 234 may utilize the stored data to generate cash flow KPIs including operating cash (Monthly summation of Operating Cash; Operating Cash=Summation of (Insurance Payments+Patient Responsibility Payments+Insurance Adjustment Payments), days cash on hand (Monthly average for summation of Operating Cash; Days Cash on Hand=Operating Cash/Cash Burn Rate (supplied by hospital), and the like.

In another example, with respect to supply chains, the analytics visualization tool 230 and/or healthcare analytics processor 234 may generate an interface that displays information relating to supply chain costs, inventory and contracts. Organizations have a better view into their business and can compare volumes and pricing of various vendors they use to receive their supply chain goods. They are also able to see what is purchased on and off contract and when current contracts are due to expire. By having this analysis, an organization can make well-informed decisions regarding their various alternatives in this space and be able to increase efficiency and reduce costs while doing so. In another example, with respect to account payable and receivable, the analytics visualization tool 230 and/or healthcare analytics processor 234 may generate an interface that enables the user to determine anticipated revenue from non-clinical (gift shop, parking, cafeteria, etc.) as well as clinical sources. These dashboards have various filters to manipulate the data and also show projections for payables and receivables.

In another embodiment, healthcare analytics processor 234 may forecast and predict future trends by using predictive modeling tools. In one embodiment, the data analytics models track operating cash, revenue cycle, and clinical metrics against the healthcare provider's internal targets or forecasts. In another embodiment, the healthcare analytics accelerate and simplify decision-making with access to enterprise-wide data, and minimize manual and labor intensive reporting. In another embodiment, the healthcare analytics reduces organizational risk by helping to provide insight at a strategic level. It should be appreciated that the predictive analytics may combine clinical, supply chain and claims data to allow a healthcare provider to compare and contrast how changes in choice of medical devices, medicines, etc. impact both clinical outcomes and profits by physicians, specialties, and payers. For example, the system may enable the user to compare and contrast the impact of different changes or choices made within the healthcare provider utilizing the analytics.

In an embodiment, shown in FIG. 2, the business support layer 166 provides support tool provided by the ACH 180, clinical quality measurement solutions provider 194, third party data sources 204, and health supply chain management solutions 196. Specifically, data provided by provided by the ACH 180, clinical quality measurement solutions provider 194, third party data sources 204, and health supply chain management solutions 196 in the data collection, processing and storage layers of the healthcare analytics system is only a subset of information available for processing. Additional information is available for direct access by the user at the business partner's web site.

Those skilled in the art will appreciate that the embodiments described herein can be implemented using a server, computer, database, communications and programming technology, each of which implements hardware or software or any combination thereof. Embodiments of this disclosure may be implemented in the form of a computer program product on a computer-readable storage medium having computer-readable program code means embodied in any suitable computer-readable storage medium, including hard disks, CD-ROM, RAM, ROM, optical storage devices, magnetic storage devices, and/or the like.

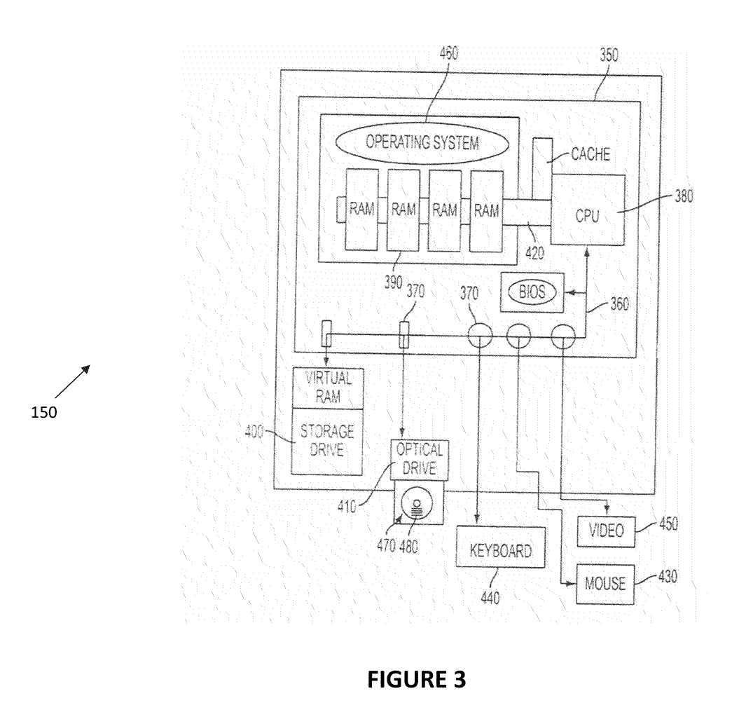

For example, FIG. 3 illustrates a high level block diagram of an exemplary computer system 340 which may be used to perform embodiments of the processes disclosed herein, including but not limited to the analysis processes of the healthcare analytics processor 110. It may be appreciated that in some embodiments, the system performing the processes herein may include some or all of the computer system 340. In some embodiments, the computer system 340 may be linked to or otherwise associated with other computer systems 340. In an embodiment the computer system 340 has a case enclosing a main board 350. The main board has a system bus 360, connection ports 370, a processing unit, such as Central Processing Unit (CPU) 380, and a data storage device, such as main memory 390, storage drive 400, and optical drive 410. Each of main memory 390, storage drive 400, and optical drive 410 may be of any appropriate construction or configuration. For example, in some embodiments storage drive 400 may comprise a spinning hard disk drive, or may comprise a solid-state drive. Additionally, optical drive 410 may comprise a CD drive, a DVD drive, a Blu-ray drive, or any other appropriate optical medium.

Memory bus 420 couples main memory 390 to CPU 380. A system bus 460 couples storage drive 400, optical drive 410, and connection ports 370 to CPU 380. Multiple input devices may be provided, such as for example a mouse 430 and keyboard 440. Multiple output devices may also be provided, such as for example a video monitor 450 and a printer (not shown). In an embodiment, such output devices may be configured to display information regarding the processes disclosed herein, including but not limited to cash amounts, transaction details, and so on. It may be appreciated that the input devices and output devices may alternatively be local to the computer system 340, or may be located remotely (e.g., interfacing with the computer system 340 through a network or other remote connection).

Computer system 340 may be a commercially available system, or may be proprietary design. In some embodiments, the computer system 340 may be a desktop workstation unit, and may be provided by any appropriate computer system provider. In some embodiments, computer system 340 comprise a networked computer system, wherein memory storage components such as storage drive 400, additional CPUs 380 and output devices such as printers are provided by physically separate computer systems commonly tied together in the network. Those skilled in the art will understand and appreciate the physical composition of components and component interconnections comprising computer system 340, and select a computer system 340 suitable for performing the methods disclosed herein.

When computer system 340 is activated, preferably an operating system 460 will load into main memory 390 as part of the boot sequence, and ready the computer system 340 for operation. At the simplest level, and in the most general sense, the tasks of an operating system fall into specific categories—process management, device management (including application and user interface management) and memory management.

In such a computer system 340, the CPU 380 is operable to perform one or more methods of the systems, platforms, components, or modules described herein. Those skilled in the art will understand that a computer-readable medium 470, on which is a computer program 480 for performing the methods disclosed herein, may be provided to the computer system 340. The form of the medium 470 and language of the program 480 are understood to be appropriate for computer system 340. Utilizing the memory stores, such as one or more storage drives 400 and main system memory 390, the operable CPU 380 will read the instructions provided by the computer program 480 and operate to perform the methods disclosed herein.

In embodiments the CPU 380 (either alone or in conjunction with additional CPUs 380) may be configured to serve as the healthcare analytics processor 110, and thus may be configured to execute one or more computer program modules, each configured to perform one or more functions of the systems, platforms, layer, components, or modules described herein. For example, each layer of the healthcare analytics system 150 may be executed by one or more computer program modules. It may be appreciated that in an embodiment, the one or more computer program modules may be configured to transmit the analytic interfaces for viewing on an electronic display communicatively linked with the one or more processors, a graphical user interface, which may be displayed on a display associated with the healthcare analytics system.

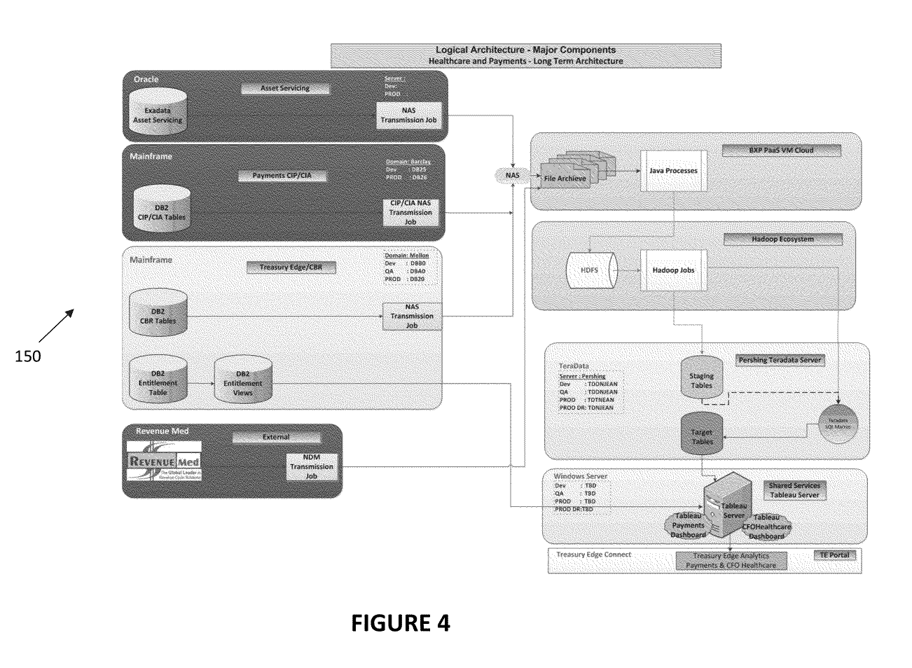

FIG. 4 illustrates an embodiment of a logical architecture of a system for providing healthcare analytics including the major components of the logical computer architecture.

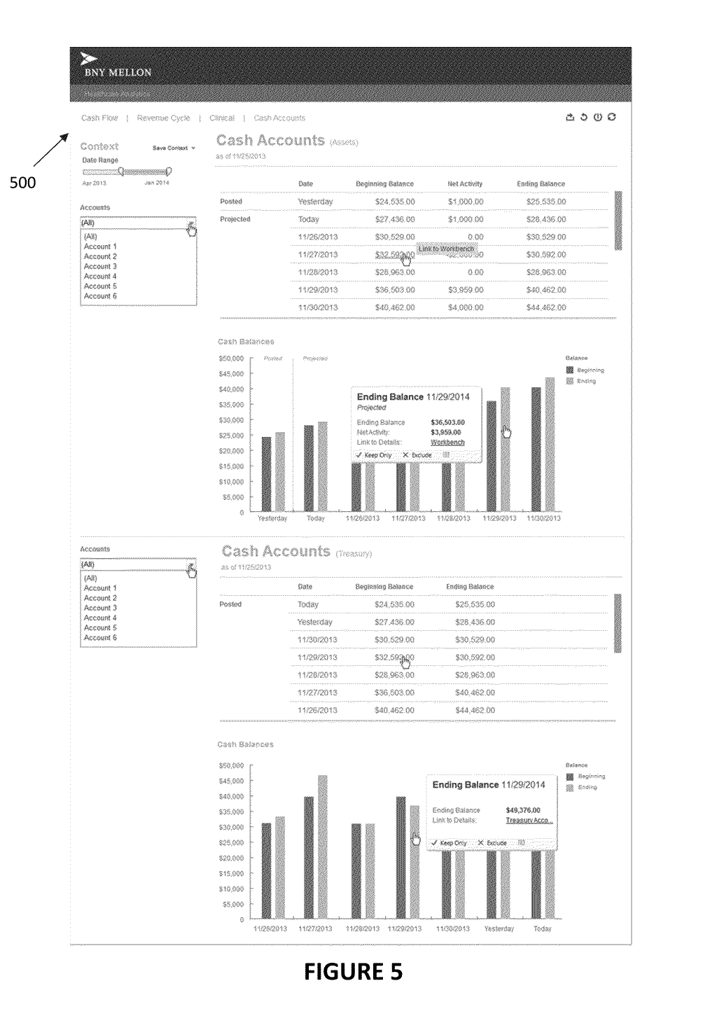

FIG. 5 illustrates an exemplary embodiment of an account/investment analytics interface 500 generated and displayed by the healthcare analytics system. In an embodiment, the account/investment analytics interface 500 includes data from investment management as well as working capital management and is designed to help the client understand their historical, current, and future financial situation. The data displayed on the account/investment analytics interface 500 includes strictly cash balances. These accounts have the ability to be projected out 5 days and have an embedded link to a client investment management system for more detailed information. The data displayed in account/investment analytics interface 500 also includes historical and current information on beginning and ending balances of various accounts. In an embodiment, the user has the ability to view account information for a plurality of accounts using a date filter. It may be appreciated that the account/investment analytics interface 500 includes a summary of cash accounts (assets) for the healthcare entity including the date of the account, beginning balance, net activity, and ending balance for each account. It may also be appreciated that summary of cash accounts may also include projected values for beginning balance, net activity, and ending balance for a date range selected by the user. In may also be appreciated that the account/investment analytics interface 500 includes a graphical representation of the cash accounts (assets) including the beginning balance and ending balance for a specified cash account. It may be appreciated that the account/investment analytics interface 500 includes a summary of cash accounts (treasury) for the healthcare entity including the date of the account, beginning balance, and ending balance for each account for the dates specified by the user. In may also be appreciated that the account/investment analytics interface 500 includes a graphical representation of the cash accounts (treasury) including the beginning balance and ending balance for a specified cash account for the dates specified by the user. In one embodiment, the cash account analytics interface 500 may show open ledger amounts, credits, debits, closing ledger amounts, investment amounts, total balance, and the like.

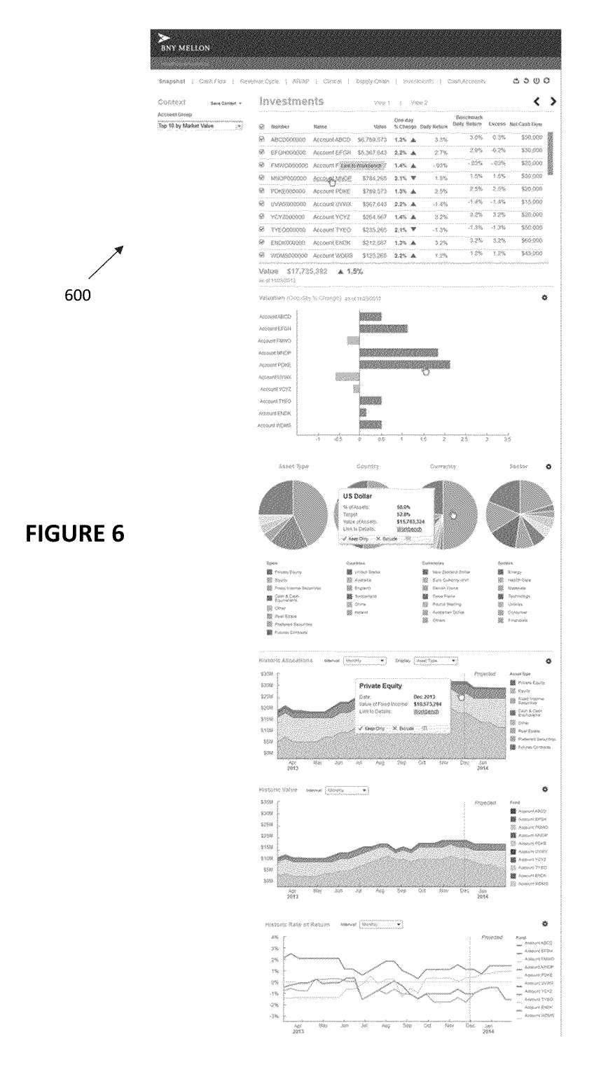

FIG. 6 illustrates another exemplary embodiment of an account/investment analytics interface 600 generated and displayed by the healthcare analytics system. It may be appreciated that the account/investment analytics interface 600 includes a listing of investments associated with an account group including the investment number, name, value, one-day change percentage, daily return, benchmark daily return, excess, and net cash flow for each investment. It may also be appreciated that the account/investment analytics interface 600 includes the total value and percentage change of the investment associated with the healthcare entity. It may further be appreciated that the account/investment analytics interface 600 further includes one or more graphical representations of the healthcare entity's investments including graphical representations of valuation, asset type, country, currency, sector, historic allocations, historic values, and historic rate of return.

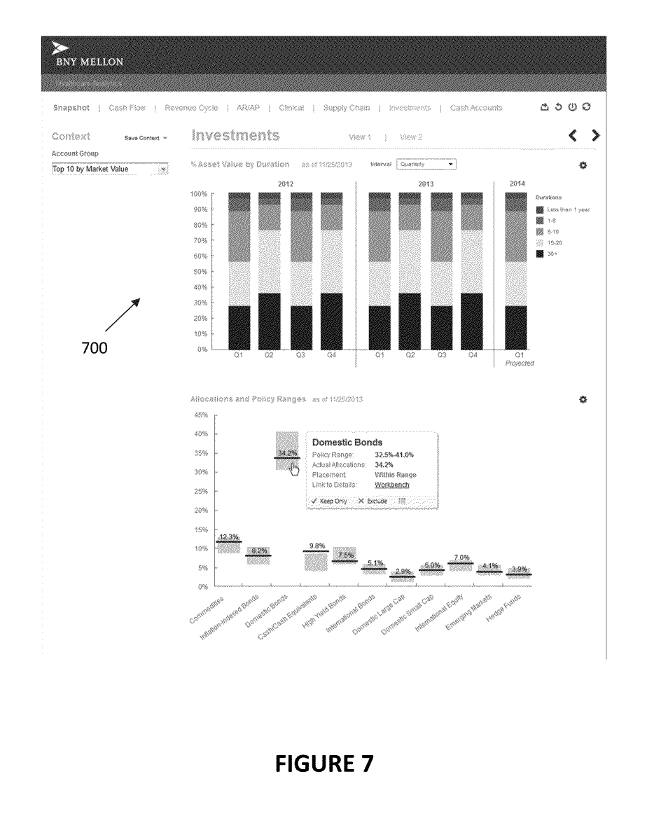

FIG. 7 illustrates another exemplary embodiment of an account/investment analytics interface 700 generated and displayed by the healthcare analytics system. It may be appreciated that the account/investment analytics interface 700 includes a graphical representation of percentage asset value by duration and the allocations and policy ranges including the policy range, actual allocation, and placement for the various type of investment of the healthcare entity.

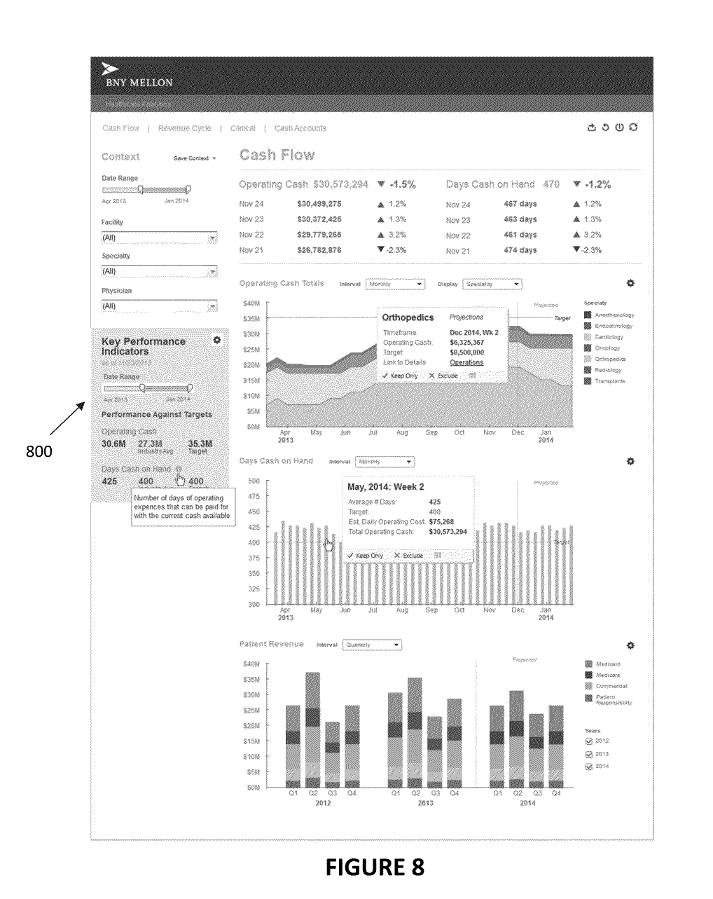

FIG. 8 illustrates an exemplary embodiment of a cash flow analytics interface 800 generated and displayed by the healthcare analytics system. In an embodiment, the cash flow analytic interface 800 provides the healthcare entity an understanding of their operating cash position as well as where their sources of revenue are coming from. The user may display data at a facility, specialty or physician level and track and monitor performance by using an index of key performance indicators. Some examples of information being displayed are operating cash totals, days cash on hand, and patient revenue. Users also have the ability to input data pertaining to their specific business and set targets. In an embodiment, the user has the ability to view cash flow information using a date filter, facility selection menu, specialty selection menu, and physician selection menu. It may be appreciated that the cash flow analytics interface 800 includes a summary of the operating cash and percentage change for the healthcare entity for the dates specified by the user. It may further be appreciated that the cash flow analytics interface 800 includes the total operating cash of the healthcare entity as well as the percentage change and days cashes on hand. In may also be appreciated that the cash flow analytics interface 800 includes a graphical representation of the operating cash totals, days cash on hand, and patient revenue for the dates specified by the user. It may also be appreciated that the cash flow analytics interface 800 further includes key performance indicators (KPIs) which provide the performance of the healthcare entity against targets (industry average, target, etc.) for a specified date range for operating cash, and days cash of hand. In one embodiment, the cash flow analytics may enable a user to select a bottom N or top N representation.

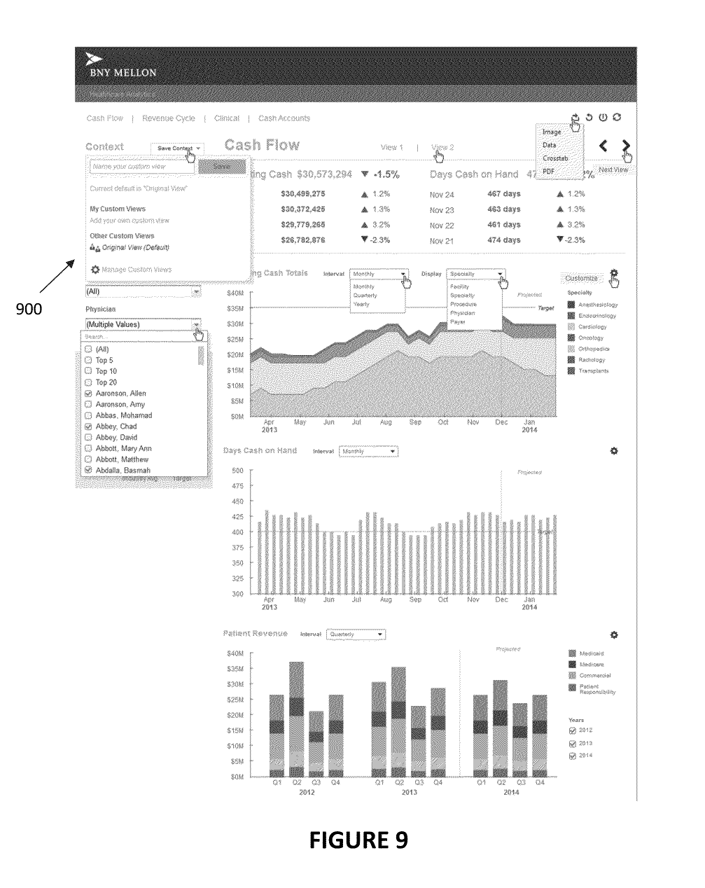

FIG. 9 illustrates another exemplary embodiment of a cash flow analytic interface 900 generated and displayed by the healthcare analytics system. The cash flow analytic interface 900 is the same as the cash flow analytic interface 800 of FIG. 8. However, it may be appreciated that cash flow analytic interface 900 further includes the physician selection menu including a listing of physicians as well as all physicians, top 5 physicians, top 10 physician, and top 20 physicians. It may be further appreciated that cash flow analytic interface 900 also include a custom view interface which enables the user to customize the view of the cash flow interface via one or more settings icons.

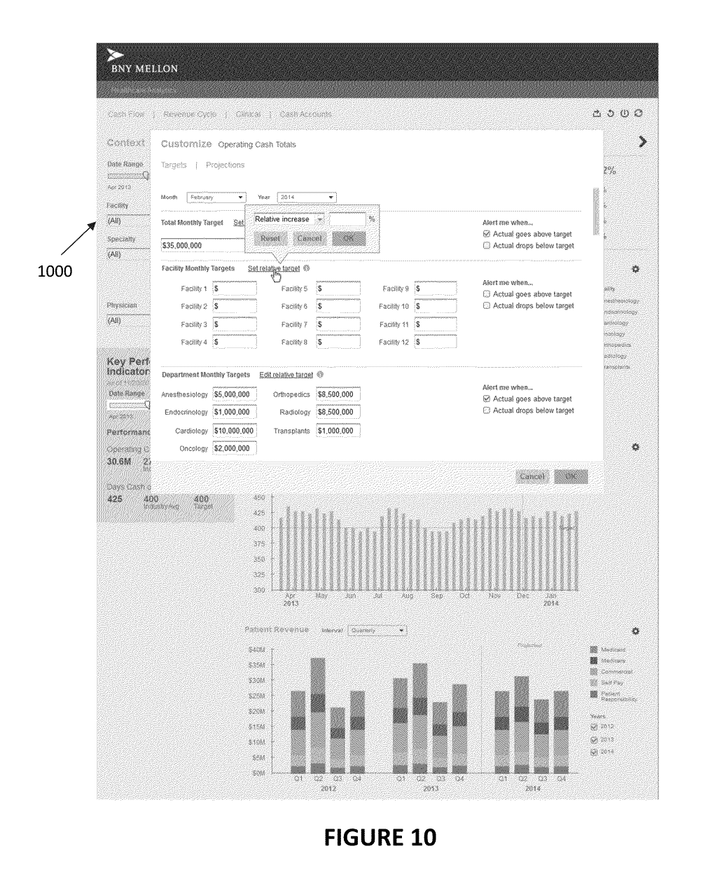

FIG. 10 illustrates another exemplary embodiment of a cash flow analytic interface 1000 generated and displayed by the healthcare analytics system. The cash flow analytic interface 1000 is the same as the cash flow analytic interface 800 of FIG. 8. However, it may be appreciated that cash flow analytic interface 1000 further includes a customized menu which enables the user to select input targets for the operating cash totals. Specifically, the cash flow analytic interface 1000 enables the user to input targets, such as total monthly target, the facility monthly targets, and department monthly targets. It may be appreciated that cash flow analytic interface 1000 further enables the user to select a relative percentage increase of the targets for a designated cash flow and to issue alerts when the actual cash flow goes above or drops below target.

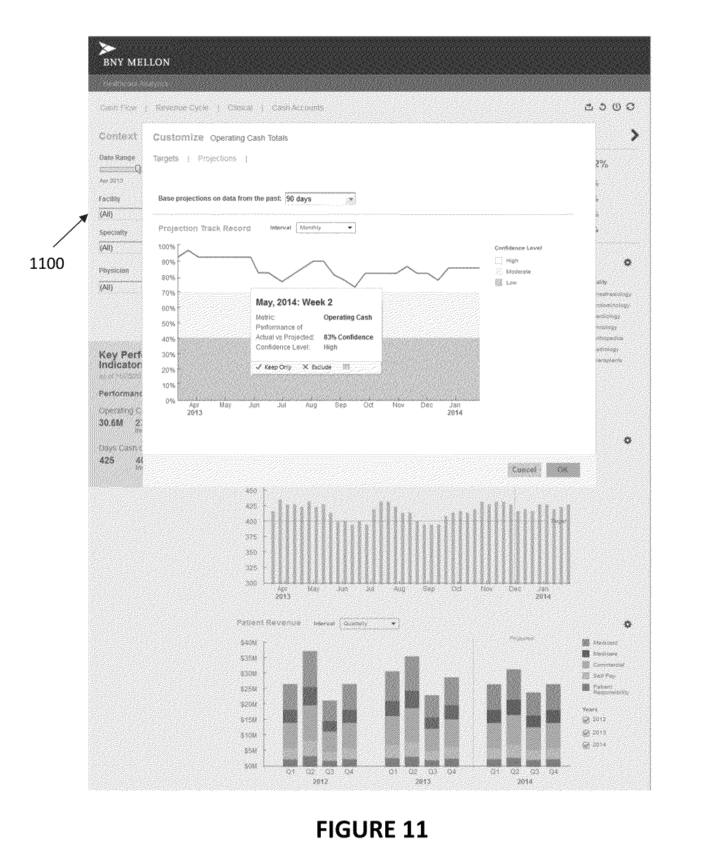

FIG. 11 illustrates another exemplary embodiment of a cash flow analytic interface 1100 generated and displayed by the healthcare analytics system. The cash flow analytic interface 1100 is the same as the cash flow analytic interface 800 of FIG. 8. However, it may be appreciated that cash flow analytic interface 1100 includes a customizable graphical representation of the projection or target track record for the operating cash total including a confidence factor for a specific date range selected by the user.

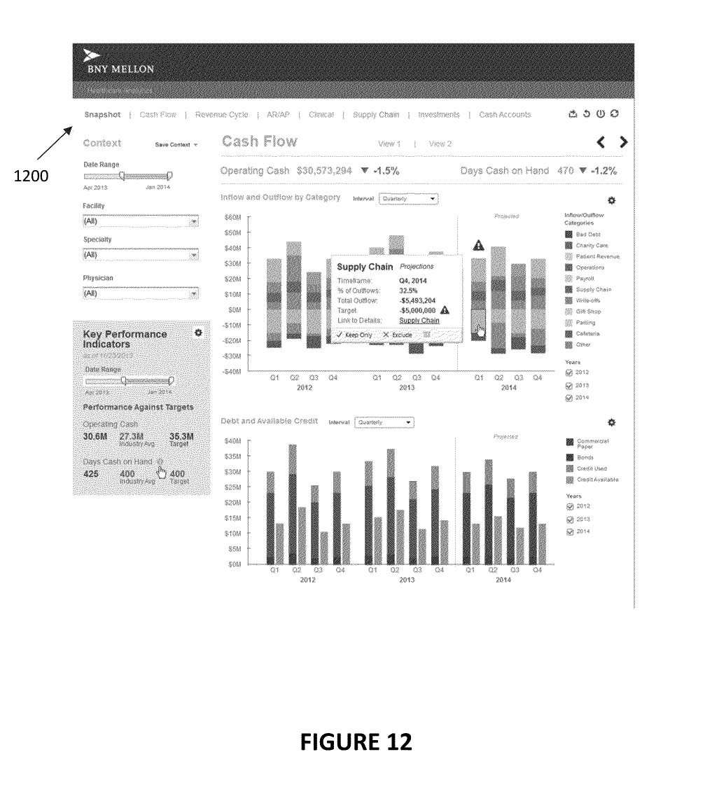

FIG. 12 illustrates another exemplary embodiment of a cash flow analytic interface 1200 generated and displayed by the healthcare analytics system. In an embodiment, the user has the ability to view cash flow information using a date filter, facility selection menu, specialty selection menu, and physician selection menu. It may be appreciated that the cash flow analytic interface 1200 includes the total operating cash flow for the healthcare entity, percentage change of cash flow, and days cash on hand. It may further be appreciated that the cash flow analytic interface 1200 further includes one or more graphical representations for inflow and outflow by category of cash flow and deb and available credit. It may also be appreciated that the cash flow analytics analytic interface 1200 further includes key performance indicators (KPIs) which provide the performance of the healthcare entity against targets (industry average, target, etc.) for a specified date range for operating cash and days cash on hand.

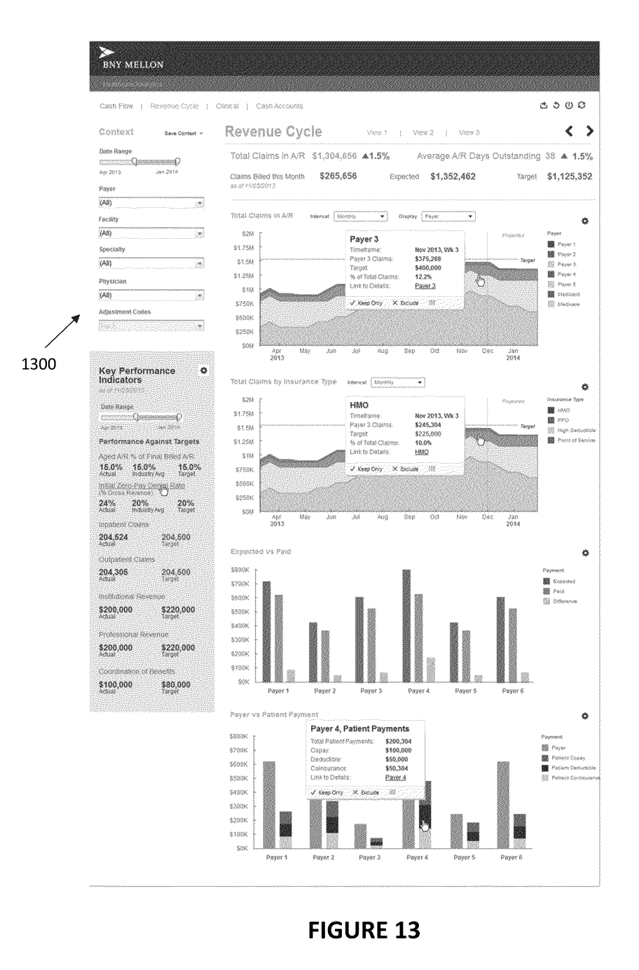

FIG. 13 illustrates an exemplary embodiment of a revenue cycle analytic interface 1300 generated and displayed by the healthcare analytics system. In an embodiment, the revenue cycle analytic interface 1300 provides the user an insight into the healthcare organization's process for managing claim processing, receiving payment and generating revenue. It is important to keep track of the claim at every point in its life cycle, therefore, the revenue cycle analytic interface 1300 provides this ability through graphs such as total claims in A/R, total claims by insurance type, payer comparisons, payer versus patient payment and so on. The revenue cycle analytic interface 1300 also addresses denied claims and adjustments taken on those claims which ultimately affect the organization's revenue opportunity. There are various filters, as mentioned above, as well as key performance indicators specific to revenue cycle. In another embodiment, the user has the ability to view revenue cycle information using a date filter, payer selection menu, facility selection menu, specialty selection menu, and physician selection menu. It may be appreciated that the revenue cycle analytic interface 1300 includes a summary of the revenue cycle including total claims in A/R, a percentage change in the total claims in A/R, an average A/R days outstanding, a percentage change in average A/R days outstanding, claims billed this month, expected revenue, and target revenue. It may be appreciated that the revenue cycle analytic interface 1300 further includes one or more graphical representations of total claims in A/R, total claims by insurance type, expected versus paid revenue, and payer versus patient payment for a date range specified by the user. It may also be appreciated that the revenue cycle analytic interface 1300 further includes key performance indicators (KPIs) which provide the performance of the healthcare entity against targets (industry average, target, etc.) for a specified date range for aged A/R percentage of final billed A/R, initial zero-pay denial rate, inpatient claims, outpatient claims, institutional revenue, professional revenue, and coordination of benefits.

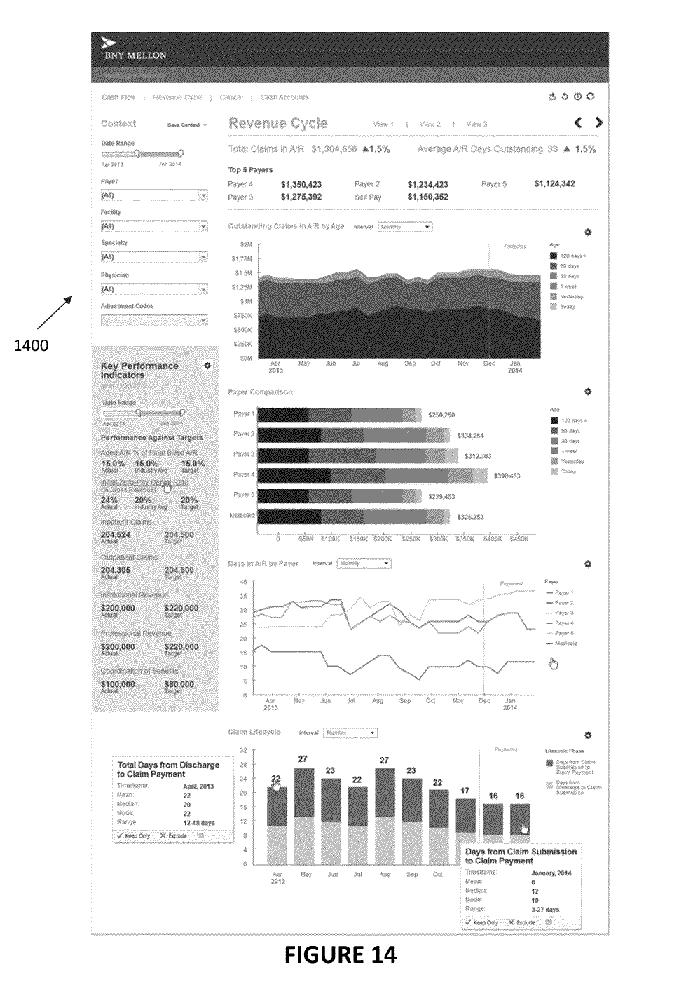

FIG. 14 illustrates another exemplary embodiment of a revenue cycle analytic interface 1400 generated and displayed by the healthcare analytics system. In another embodiment, the user has the ability to view revenue cycle information using a date filter, payer selection menu, facility selection menu, specialty selection menu, and physician selection menu. It may be appreciated that the revenue cycle analytic interface 1400 includes one or more graphical representations of outstanding claims in A/R by age, payer comparison, days in A/R by payer, and claim lifestyle for a date range specified by the user. In one embodiment, the revenue cycle analytics may display claim and provider adjustment analytics as well as denial analytics.

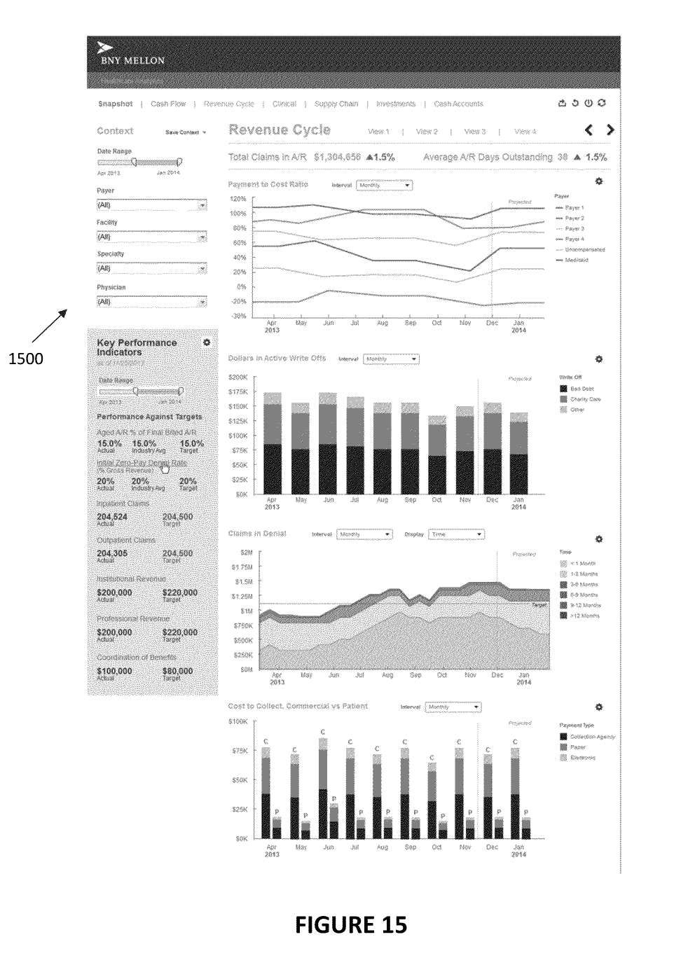

FIG. 15 illustrates another exemplary embodiment of a revenue cycle analytic interface 1500 generated and displayed by the healthcare analytics system. In another embodiment, the user has the ability to view revenue cycle information using a date filter, payer selection menu, facility selection menu, specialty selection menu, and physician selection menu. It may be appreciated that the revenue cycle analytic interface 1500 includes one or more graphical representations of payment to cost ratio, dollars in active write offs, claims in denial, and cost to collect and commercial versus patient.

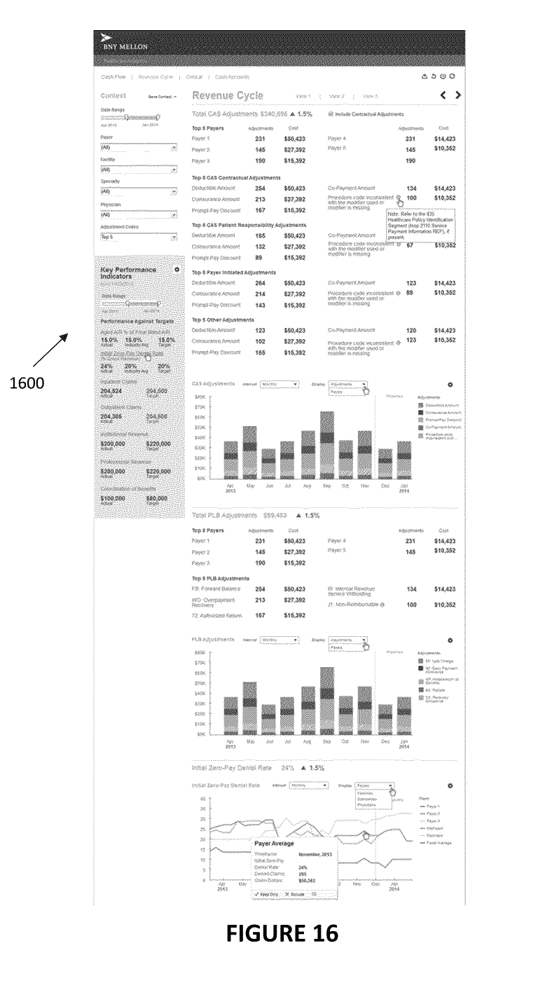

FIG. 16 illustrates another exemplary embodiment of a revenue cycle analytic interface 1600 generated and displayed by the healthcare analytics system. In another embodiment, the user has the ability to view revenue cycle information using a date filter, payer selection menu, facility selection menu, specialty selection menu, and physician selection menu. It may be appreciated that the revenue cycle analytic interface 1600 includes the total claim level adjustment (CAS) with the percentage change in the CAS adjustment, top five payer information, top five CAS contractual adjustments, top five CAS patient responsibility adjustments, top five payer initiated adjustments, and top five other adjustments. It may also be appreciated that the revenue cycle analytic interface 1600 includes one or more graphical representations of CAS adjustments, total provider level adjustment (PLB) adjustments, PLB adjustments, and initial zero-pay denial rate.

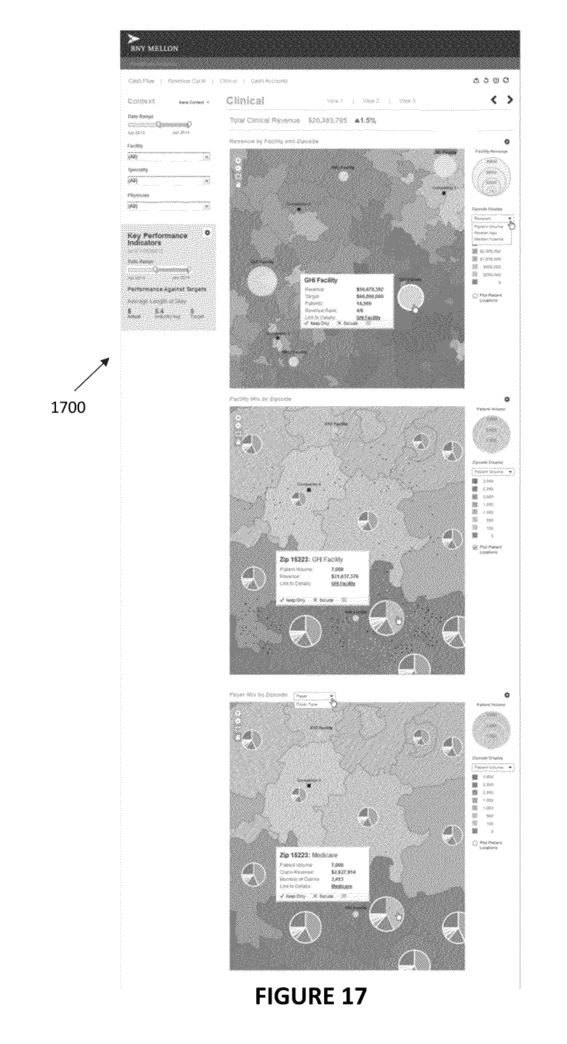

FIG. 17 illustrates an exemplary embodiment of a clinical analytic interface 1700 generated and displayed by the healthcare analytics system. In an embodiment, the clinical analytic interface 1700 addresses many important factors dealing with the financial performance of the healthcare entity in regards to treating patients. This includes volume of inpatient and outpatient visits, length of stay, volume by specialty, geographical patient distribution and much more. In addition, the invention provides benchmarking of clients against industry averages and tracking particular key performance indicators over time. This directly helps the healthcare entity become more efficient and so they are able to provide higher quality care. In an embodiment, the user has the ability to view clinical information using a date filter, facility selection menu, specialty selection menu, and physician selection menu. It may be appreciated that the clinical analytic interface 1700 includes the total clinical revenue and the percentage change in total clinical revenue. It may also be appreciated that the clinical analytic interface 1700 includes one or more graphical representations of revenue by facility and zip code, facility mix by zip code, and payer mix by zip code. It may also be appreciated that the clinical analytic interface 1700 further includes key performance indicators (KPIs) which provide the performance of the healthcare entity against targets (industry average, target, etc.) for a specified date range for average length of stay.

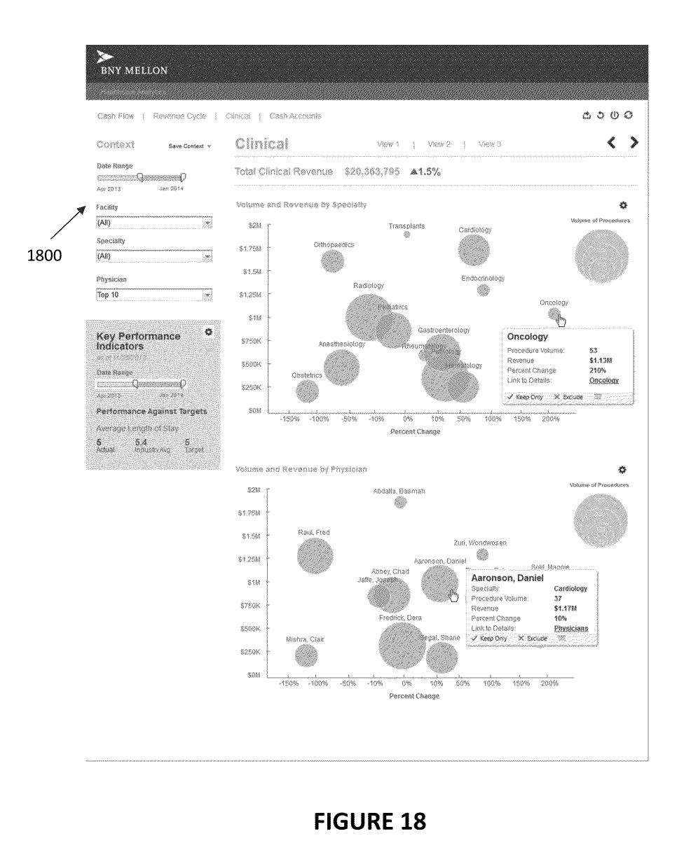

FIG. 18 illustrates another exemplary embodiment of a clinical analytic interface 1800 generated and displayed by the healthcare analytics system. In an embodiment, the user has the ability to view clinical information using a date filter, facility selection menu, specialty selection menu, and physician selection menu. It may be appreciated that the clinical analytic interface 1800 includes the total clinical revenue and the percentage change in total clinical revenue. It may be appreciated that the clinical analytic interface 1800 includes one or more graphical representation of volumes and revenue by specialty and volume and revenue by physician.

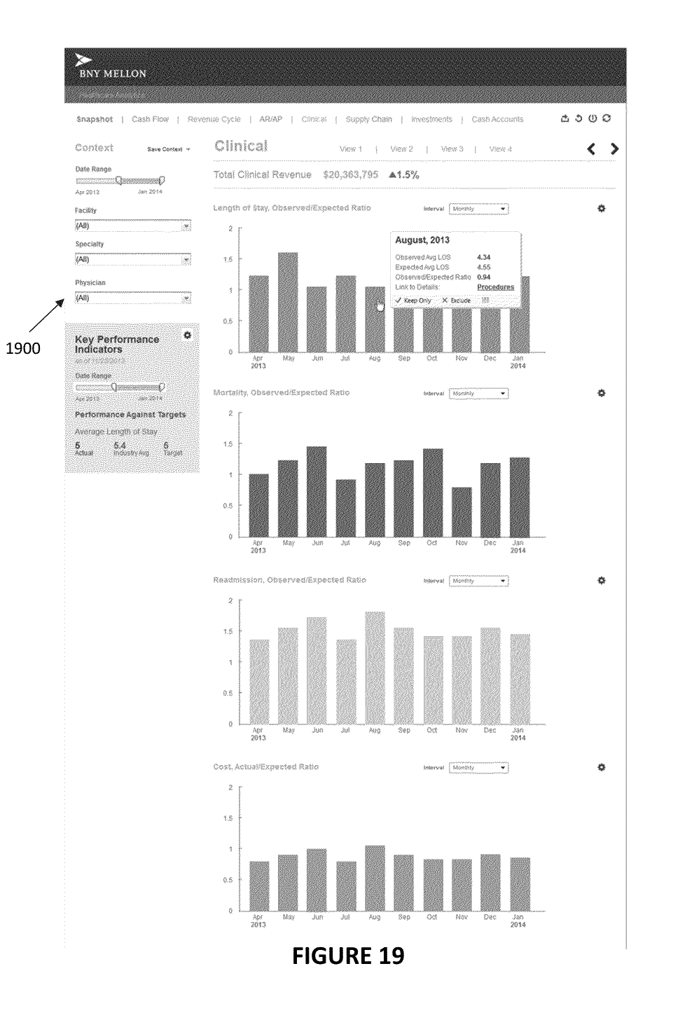

FIG. 19 illustrates another exemplary embodiment of a clinical analytic interface 1900 generated and displayed by the healthcare analytics system. In an embodiment, the user has the ability to view clinical information using a date filter, facility selection menu, specialty selection menu, and physician selection menu. It may be appreciated that the clinical analytic interface 1900 includes the total clinical revenue and the percentage change in total clinical revenue. It may be appreciated that the clinical analytic interface 1900 includes one or more graphical representations of length of stay including observed expected ratio, mortality including observed expected ratio, readmission including observed expected ratio, and cost including actual and expected ratio.

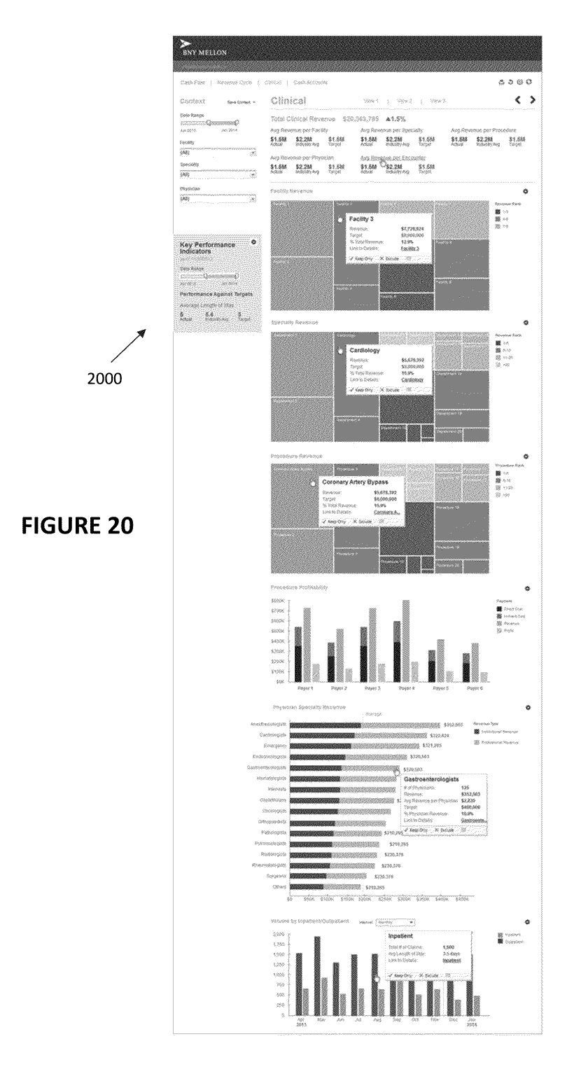

FIG. 20 illustrates another exemplary embodiment of a clinical analytic interface 2000 generated and displayed by the healthcare analytics system. In an embodiment, the user has the ability to view clinical information using a date filter, facility selection menu, specialty selection menu, and physician selection menu. It may be appreciated that the clinical analytic interface 2000 includes the total clinical revenue, the percentage change in total clinical revenue, average revenue per family, average revenue per specialty, average revenue per procedure, average revenue per physician, and average revenue per encounter. It may be appreciated that the clinical analytic interface 2000 includes one or more graphical representations of facility revenue, specialty revenue, procedure revenue, procedure profitability, physician specialty revenue, and volume by inpatient/outpatient.

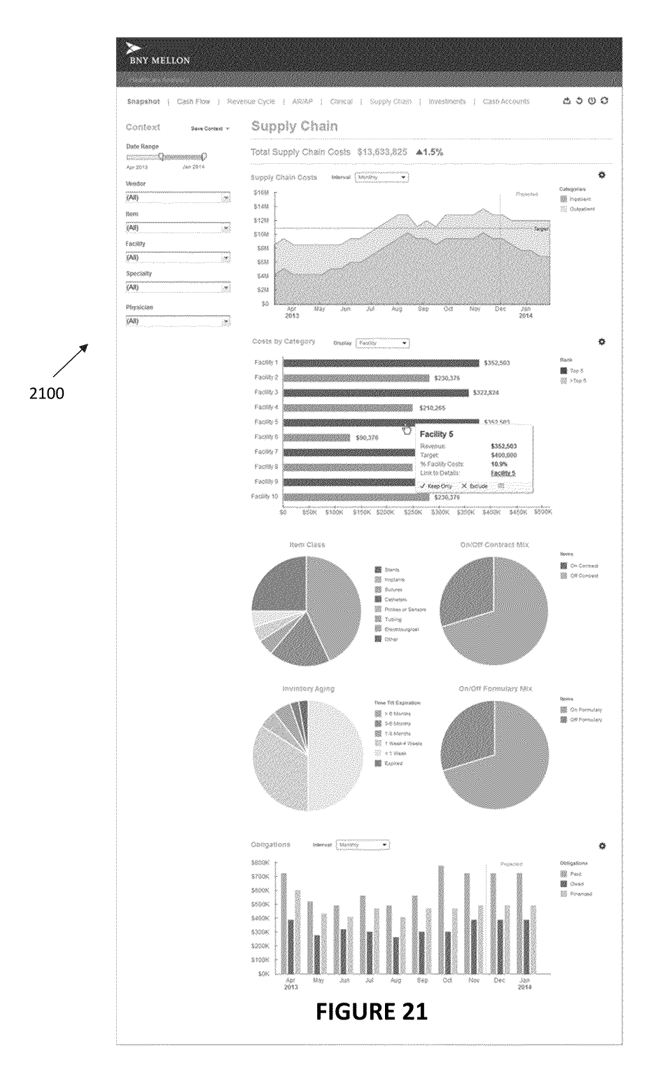

FIG. 21 illustrates an exemplary embodiment of a supply chain analytic interface 2100 generated and displayed by the healthcare analytics system. In an embodiment, the supply chain analytic interface 2100 relates to supply chain costs, inventory and contracts. The supply chain analytic interface 2100 provides the healthcare entity a better view into its business and can compare volumes and pricing of various vendors it uses to receive goods from its supply chain. The supply chain analytic interface 2100 also provides what is purchased on and off contract and when current contracts are due to expire. By having this analysis, the healthcare analysis can make well-informed decisions regarding their various alternatives in this space and be able to increase efficiency and reduce costs while doing so. In an embodiment, the user has the ability to view supply chain information using a date filter, facility selection menu, specialty selection menu, and physician selection menu. It may be appreciated that the supply chain analytic interface 2100 includes the total supply chain cost as well as the percentage change in the total supply chain cost. It may also be appreciated that the supply chain analytic interface 2100 includes one or more graphical representations of total supply chain costs, costs by category, item class, on/off contract mix, inventory aging, on/off formulary mix, and obligations.

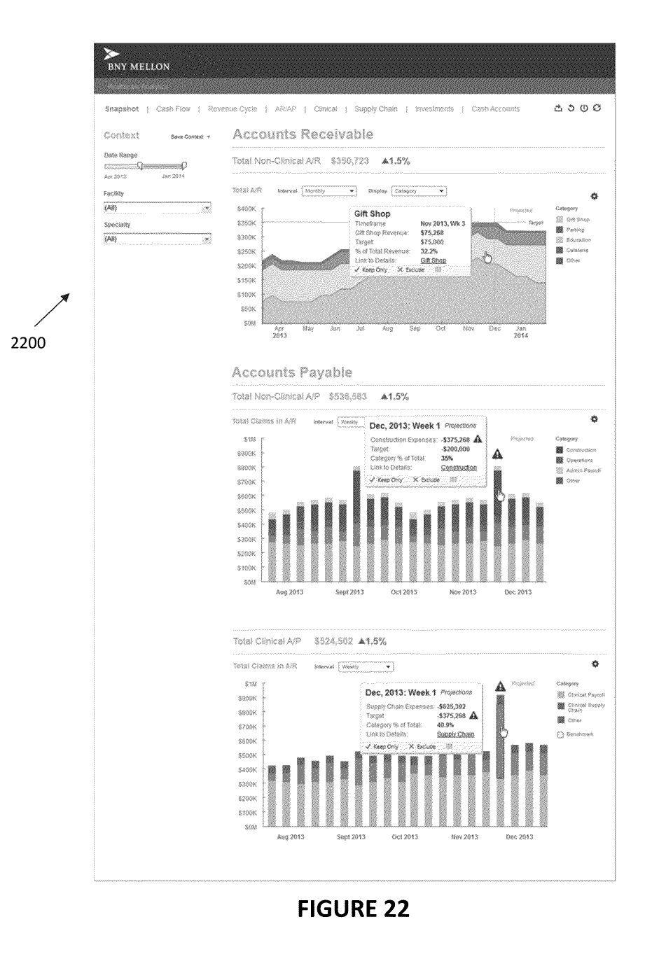

FIG. 22 illustrates an exemplary embodiment of an account payable/receivable analytic interface 2200 generated and displayed by the healthcare analytics system. In an embodiment, the account payable/receivable analytic interface 2200 enables the user to determine anticipated revenue from non-clinical (gift shop, parking, cafeteria, etc.) as well as clinical sources. The account payable/receivable analytic interface 2200 includes various filters to manipulate the data and also show projections for payables and receivables. In an embodiment, the user has the ability to view account payable/receivable information using a date filter, facility selection menu, and specialty selection menu. It may be appreciated that the account payable/receivable analytic interface 2200 includes one or more graphical representations of accounts receivable including total non-clinical A/R and account payable including total non-clinical A/P and total clinical A/P.

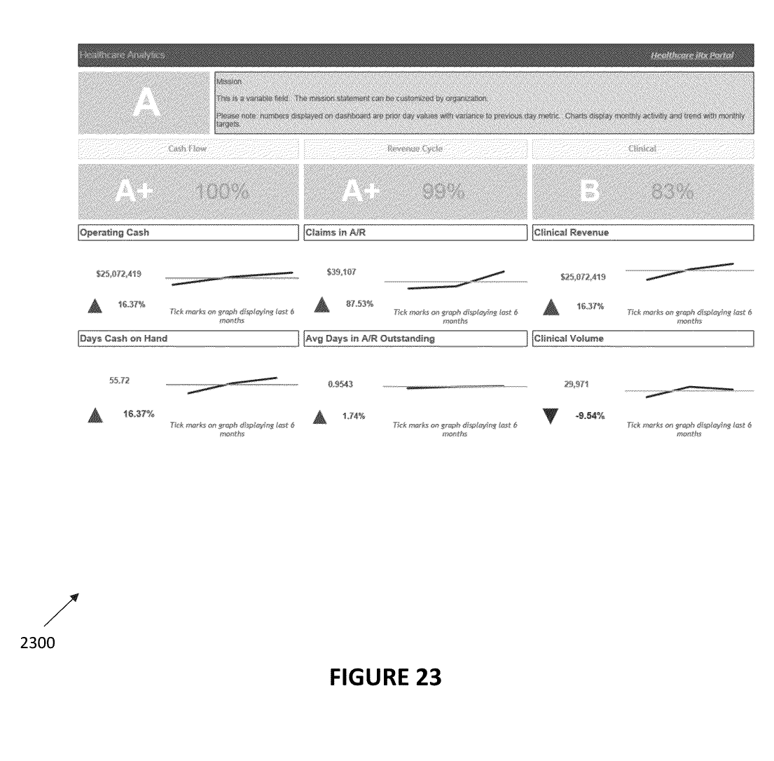

FIG. 23 illustrates an exemplary embodiment of a key performance indicator interface 2300 generated and displayed by the healthcare analytics system. In one embodiment, the KPI interface 2300 includes a scorecard including an overall score, a cash flow score, revenue cycle score, clinical score, and the like. The KPI interface also may show the data trend for a time period and percentage change for the healthcare entity's operating cash, claims in A/R, clinical revenue, days cash on hand, average days in A/R outstanding, clinical volume, and the like.

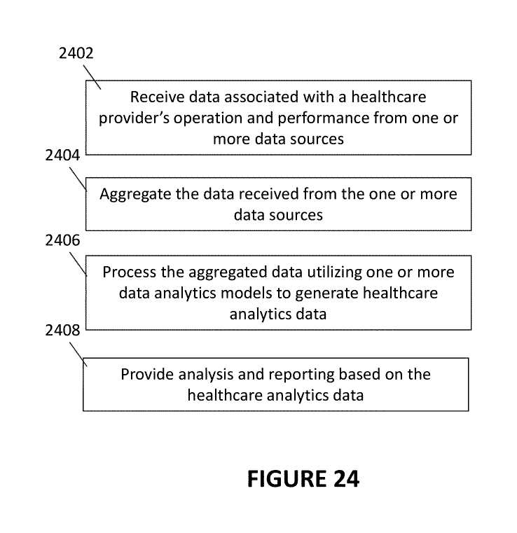

FIG. 24 illustrates an embodiment of a method 2400 of the present disclosure. It may be appreciated that the method 2400 may be performed by any appropriate system or systems (such as at the healthcare analytics processors 150, and may be implemented on one or more computer processors, such as the CPU 380. As shown, in an embodiment the method starts at 2402 by receiving data associated with a healthcare provider's operation and performance from one or more data sources. In an embodiment, the method 2400 may continue at 2404 aggregating the data received from the one or more data sources. In an embodiment, method 2400 may continue at 2406 by processing the aggregated data utilizing one or more data analytics models to generate healthcare analytics data. In an embodiment, method 2400 may continue at 2407 by providing analysis and reporting based on the healthcare analytics data. It may be appreciated that the analysis and reporting enables a user to view and manipulate integrated data relating to revenue cycles, investments, supply chains, and clinical and population health metrics; forecast and predict future trends by using predictive modeling tools; provide access to enterprise-wide data; and provide insight at a strategic level.

The above-discussed embodiments and aspects of this disclosure are not intended to be limiting, but have been shown and described for the purposes of illustrating the functional and structural principles of the inventive concept, and are intended to encompass various modifications that would be within the spirit and scope of the following claims.

Various embodiments may be described herein as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What is claimed is:

1. A system for providing data analytics at a healthcare entity, the system comprising:
a computer system comprising one or more physical processors programmed with computer program instructions that, when executed, cause the computer system to:
receive data associated with a healthcare provider's operation and performance from one or more data sources;
aggregate the data received from the one or more data sources;
process the aggregated data utilizing one or more data analytics models to generate healthcare analytics data; and
provide analytics and reporting based on the healthcare provider's operation and performance.

2. The system of claim 1, wherein the received data is in a plurality of formats; and wherein the one or more physical processors are further programmed to:
convert the data received in the plurality of formats to a single format.

3. The system of claim 1, wherein the data analytics models include at least revenue cycle analytics, cash flow analytics, clinical analytics, supply chain analytics, and key performance indicator analytics.

4. The system of claim 3, wherein the cash flow analytics include at least one of operating cash and days cash on hand.

5. The system of claim 3, wherein the revenue cycle analytics include at least one of total claims in accounts receivable, average account receivable days outstanding, claim lifecycle, total claim adjustments, and denial rate.

6. The system of claim 3, wherein the clinical analytics include at least one of revenue by location, total clinical revenue, facility revenue, specialty revenue, physician revenue, and payer revenue.

7. The system of claim 6, wherein the revenue by location is displayed on map on a user interface, wherein each location is represented by a graphical representation and the relative size of the graphical representation corresponds the revenue for that location to provide insight into population served for expanding or sun setting service lines, facilities, etc.

8. The system of claim 3, wherein the key performance indicators are based on at least one of industry averages or target data provided by the user.

9. The system of claim 3, wherein the one or more data analytics models determine forecast and predict future trends utilizing predictive modeling tools.

10. The system of claim 9, wherein the predictive analytics combine clinical, supply chain and claims data to allow a healthcare provider to compare and contrast how changes in choice of medical devices, medicines, etc. impact both clinical outcomes and profits by physicians, specialties, and payers.

11. The system of claim 1, wherein the one or more physical processors are further programmed to:
generate and display a visualization of the provided analytics and reporting for display on a user interface.

12. The system of claim 1, wherein the one or more data analytics models track operating cash, revenue cycle, and clinical metrics against the healthcare provider's internal targets or forecasts.

13. A computer implemented method for providing data analytics at a healthcare entity, wherein the method is implemented in a computer system comprising one or more physical processors programmed with computer program instructions that, when executed by the one or more physical processors, cause the computer system to perform the method, the method comprising:
receiving data associated with a healthcare provider's operation and performance from one or more data sources;
aggregating the data received from the one or more data sources;
processing the aggregated data utilizing one or more data analytics models to generate healthcare analytics data; and
providing analysis and reporting based on the healthcare provider's operation and performance.

14. The method of claim 13, wherein the received data is in a plurality of formats; and further comprising:
converting the data received in the plurality of formats to a single format.

15. The method of claim 13, wherein the data analytics models include at least revenue cycle analytics, cash flow analytics, clinical analytics, supply chain analytics, and key performance indicator analytics.

16. The method of claim 15, wherein the cash flow analytics include at least one of operating cash and days cash on hand.

17. The method of claim 15, wherein the revenue cycle analytics include at least one of total claims in accounts receivable, average account receivable days outstanding, claim lifecycle, total claim adjustments, and denial rate.

18. The method of claim 15, wherein the revenue by location is displayed on map on a user interface, wherein each location is represented by a graphical representation and the relative size of the graphical representation corresponds the revenue for that location.

19. The system of claim 18, wherein the revenue by location is displayed on map on a user interface, wherein each location is represented by a circle and the size of the circle corresponds the revenue for that location.

20. The method of claim 15, wherein the key performance indicators are based on at least one of industry averages or target data provided by the user.

21. The method of claim 15, wherein the one or more data analytics models determine forecast and predict future trends utilizing predictive modeling tools.

22. The system of claim 13, further comprising:
generating and display a visualization of the provided analytics and reporting for display on a user interface.
